(19) United States
(12) Patent Application Publication
(10) Pub. No.: US 2005/0171667 A1
(43) Pub. Date: Aug. 4, 2005

(54) Electric power steering system and method having abnormality compensation function

(75) Inventor: Hiroyuki Morita, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/046,791

(22) Filed: Feb. 1, 2005

(30) Foreign Application Priority Data
Feb. 4, 2004 (JP) 2004-28335

(51) Int. Cl. B62D 5/04

(52) U.S. Cl. 701/43; 180/446; 701/41

(57) ABSTRACT

A vehicle electric power steering system comprises a torque sensor including a torsion bar that detects a steering force applied to the steering wheel. A first rotation angle detection device detects a rotation angle of a steering shaft connected to the torsion bar, and a second rotation angle detection device detects a rotation angle of a pinion shaft connected to the torsion bar. A steering controller detects an abnormality in an output of the torque sensor. The steering controller detects the steering torque in place of the torque sensor based on the rotation angle of the steering shaft and the pinion shaft when an abnormality of the torque sensor is detected.

### CROSS REFERENCE TO RELATED APPLICATION

This application is based on and incorporates herein by reference Japanese Patent Application No. 2004-28335 filed on Feb. 4, 2004.

### FIELD OF THE INVENTION

The present invention relates to an electric power steering system and method. More specifically, the present invention relates to a torque sensor failure compensation of an electric power steering system based on an estimated twist angle of a torque sensor.

### BACKGROUND OF THE INVENTION

In an electric power steering system for assisting an operation of a steering wheel by a driver, assisting force is cut off by a fail-safe mechanism when an abnormality of the torque sensor is detected. That is, an electric current applied to an assisting electric motor is reduced to zero just after the abnormality is detected. As a result, the operation force of the steering wheel will suddenly become very heavy because of the loss of assisting power by the electric motor.

These situations are compensated by an alternative torque sensor that detects a torque to be utilized for controlling the steering wheel, or by stopping of assisting power and the like as a fail-safe operation. However, the alternative torque sensor diminishes the mountability of the electric power steering system, and stopping of assisting power demands an increased operating force from the driver.

In a patent document U.S. Pat. No. 6,148,949 (JP-A-11-59447), steering wheel control by an estimated torque based on a steering angle from a steering angle sensor and a speed signal from a speed sensor in case of torque sensor failure is proposed in terms of mountability and loss of assisting power. In a patent document JP-A-9-58505, an alternative method is proposed that a predetermined motor current proportional to the speed of the vehicle is provided to the assisting motor with a constant decreasing ratio to zero. The other method for the torque sensor failure is proposed in a patent document JP-A-2000-185660 that, the control with a torque sensor signal is prohibited with a continued control by a system that does not use the torque sensor signal, such as a control by a steering angle information.

In the above documents, the first and the second one have an accuracy problem of steering torque caused by the location of the steering angle sensor either at the steering wheel end or at the pinion end of the torsion bar connected to the steering shaft. Moreover, the second one compels the driver to apply an increased steering force in the end (with no assisting force). The third one also has an accuracy problem as in the first and second ones, besides the lack of assisting force.

### SUMMARY OF THE INVENTION

It is thus an object of the present invention to provide a vehicle with an electric power steering system and method that continues a steering force assisting function by estimating an alternative steering torque with accuracy in case of torque sensor failure.

According to the present invention, an electric power steering system applies a steering torque to a steering mechanism based on a driver's operation of a steering wheel by supplying a current to an electric motor. In the electric power steering system a torque sensor including a torsion bar detects a steering force of the steering wheel. A controller detects a rotation angle of a steering shaft connected to the steering wheel and one end of the torsion bar, a rotation angle of a pinion shaft connected to the pinion and the other end of the torsion bar, and an abnormality in an output of the torque sensor. In the electric power steering system, the steering force of the steering wheel is detected by a device that calculates the steering force based on a rotation angle of the steering shaft and a rotation angle of the pinion shaft when an abnormality of the torque sensor is detected.

In the controller, a twist angle of the torsion bar is detected by using outputs from a motor rotation angle sensor and a steering rotation angle sensor, both of which are components of the electric power steering system. Based on the assumption that a steering torque is estimated from the twist angle of the torsion bar multiplied by a torsion bar spring constant, an alternative torque for steering assistance in case of torque sensor failure can be calculated with accuracy to extend an assisting function of the electric power steering system.

Namely, a twist angle of the torsion bar connected to the steering shaft (a steering shaft and a pinion shaft) is calculated from the output of the steering rotation angle sensor and the output of the motor rotation angle sensor, and then a steering torque is calculated from the twist angle and the spring constant of the torsion bar, and as a result, the torque is used as an alternative assisting torque for assist control of the steering wheel.

According to the structure described above, an alternative torque calculation device in case of torque sensor failure is secured and an estimated steering torque can be calculated with accuracy. The alternative assist control amount can also be calculated with accuracy. Thus, the driver of a vehicle will neither suffer from an uncomfortable feeling while operating the steering wheel, nor be compelled to apply an increased operational force for steering.

In the electric power steering system, the alternative torque calculation device determines a base position of the steering shaft and a base position of the pinion shaft when no abnormality of the torque sensor is detected and the output signal from the torque sensor is within a predetermined range. According to this structure, the steering shaft base position and the pinion shaft base position are constantly updated while the torque sensor works correctly, and as a result, the alternative assist control amount in case of torque sensor failure can be calculated with accuracy by estimating an accurate alternative steering torque based on the latest base position of those shafts.

In the electric power steering system, the alternative torque calculation device calculates an alternative steering torque from an estimation result of twist angle of the torsion bar based on the comparison of a rotation angle of one end of the torsion bar with deviation from the base position and a rotation angle of the other end of the torsion bar with deviation from the base position when an abnormality of the torque sensor is detected. According to this structure, the alternative assist control amount in case of torque sensor failure can be calculated with accuracy by estimating an accurate alternative steering torque. Thus, the driver of a vehicle will neither suffer from an uncomfortable feeling while operating the steering wheel, nor be compelled to apply an increased operational force for operating the steering wheel.

While the electric power steering system normally works with an assisting force calculation method based on the rotation angles from the rotation angle sensors and an output from the torque sensor, the assisting force calculation method is instantly switched to an alternative method that is based on the rotation angles from the rotation angle sensors and the base positions of the rotation angles when an abnormality of the torque sensor is detected.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing an electric power steering system according to the present invention; and

FIG. 2 is a flowchart showing a process for calculating a base assist control amount.

### DETAILED DESCRIPTION OF THE PREFERRED EMBODIMENT

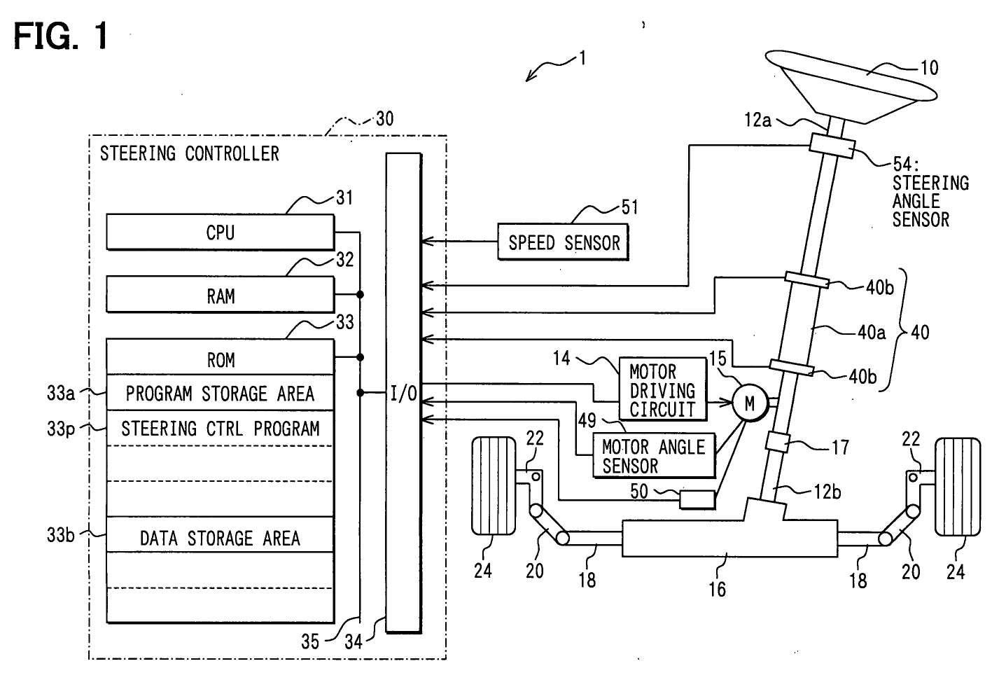

As shown in FIG. 1, in an electric power steering system 1, a steering wheel 10 is connected to a steering shaft 12a. The lower end of the steering shaft 12a is connected to a torque sensor 40. The upper end of a pinion shaft 12b is connected to the torque sensor 40. On the lower end of the pinion shaft 12b, a pinion not shown in the figure is provided. In a steering gear box 16, this pinion is engaged with a rack bar 18. One end of a tie rod 20 is connected to one end of the rack bar 18. The other end of the tie rod 20 is connected to a front tire wheel 24 through a knuckle arm 22. Similarly, one end of another tie rod 20 is connected to the other end of the rack bar 18. The other end of the other tie rod 20 is connected to another front tire wheel 24 through another knuckle arm 22. In addition, on the pinion shaft 12b, an assist motor 15 is connected through a speed reduction device 17.

The speed reduction device 17, which is comprised of gears and the like, transfers rotation of the assist motor 15 to the pinion shaft 12b, and thus the pinion shaft 12b is rotated to move the rack bar 18 resulting in steering orientation of the tire wheel 24.

The torque sensor 40 includes a well-known torsion bar 40a and a pair of resolvers 40b, 40b (angle detection sensor) attached to the torsion bar at axially extended positions. When the steering shaft 12a is rotated, a torque proportional to the rotation angle of the steering shaft 12a is applied to the torsion bar 40a. By detecting the difference of rotation angles at both ends of the torsion bar 40a with the resolvers 40b, the applied torque to the torsion bar 40a is calculated with a difference of the detected angles and a spring constant of the torsion bar 40a. The calculated torque is then sent to the steering controller 30.

A steering angle sensor 54 that detects a rotation angle of the steering wheel 10 is attached to the steering shaft 12a. The steering angle sensor 54 is comprised of a well-known rotation angle detection device, such as a rotary encoder or a reslover and operates as a first rotation angle detection means. The detected information is then sent to the steering controller 30.

A rotation angle of the motor 15 is detected by a motor rotation angle sensor 49 (a second rotation angle detection means) with a well-known rotation angle detection device, such as a rotary encoder and the like. The motor rotation angle sensor 49 may be comprised of a resolver instead of the rotary encoder. The signal from the motor rotation angle sensor 49 is sent to the steering controller 30.

The steering controller 30 comprises a well-known CPU 31, a RAM 32, a ROM 33, an I/O interface 34, and a bus line 35 that connects all of these components, and performs abnormality detection and alternative torque calculation. The CPU 31 controls programs and data stored in the ROM 33 and the RAM 32. The ROM 33 has a program storage area 33a and a data storage area 33b. A steering control program 33p is stored in the program storage area 33a. Data required for execution of the steering control program 33p is stored in the data storage area 33b.

By executing the steering control program 33p stored in the ROM 33 and processed in the CPU 31, the steering controller 30 calculates an assisting torque (a base assist control amount) corresponding to the torque detected by the torque sensor 40. The controller 30 then applies a voltage to the assist motor 15 through a motor driving circuit 14 to yield the calculated assisting torque. The controller 30 further calculates an actually applied assisting torque by detecting both of a rotation angle of the motor 15 with the motor rotation sensor 49 and a motor current with a current sensor 50, and adjusts the assisting torque by using a feedback control (assist control). The assist motor 15 of the electric power steering system 1 may either be a DC motor, a brushless motor, or the like as long as it can be integrated in the system 1. A speed sensor 51 to detect a speed of a vehicle is connected to the system 1 for an accuracy of steering control.

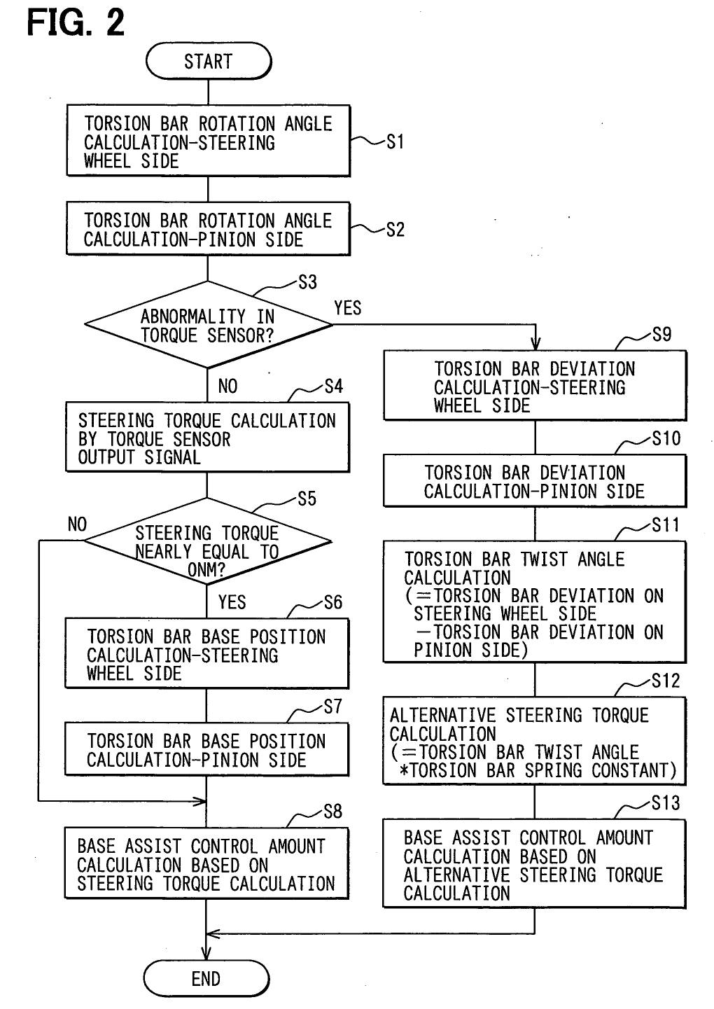

In operation, the controller 30 calculates the assist control amount by executing the steering control program 33p in the CPU 31 as shown in FIG. 2.

First, in step S1, a rotation angle of the torsion bar 40a on the steering wheel side (that is, the steering shaft 12a side) is calculated based on the signal from the steering angle sensor 54. Then, in step S2, a rotation angle of the torsion bar 40a on the pinion side (that is, the pinion shaft 12b side) is calculated based on the signal from the motor rotation angle sensor 49 and a reduction ratio of the speed reduction device 17. As the reduction ratio of the speed reduction device 17 is a constant, the rotation angle of the pinion shaft 12b can be calculated based on the rotation angle of the motor 15.

Further, the steering controller 30 continuously checks the correctness of the torque sensor 40 based on an output signal (output voltage) from the torque sensor 40. That is, torque sensor operation is determined as normal when the output voltage from the torque sensor 40 is within a predetermined range, and torque sensor operation is determined as abnormal when the output voltage from the torque sensor 40 is not within a predetermined range.

When the torque sensor operation is determined as normal (step S3: NO), a steering torque is calculated based on the output signal from the torque sensor 40 (step S4).

Further, in this case, when the steering torque fits within a predetermined range from 0 (zero) Nm (Newton meter), that is, when the vehicle is running along a straight line or the steering wheel is in neutral position (step S5: YES), a base position of the steering shaft 12a is determined by the rotation angle of the torsion bar 40a on the steering wheel side (steering shaft 12a side) based on the signal from the steering angle sensor 54 (step S6). Next, a base position of the pinion shaft 12b is determined by the rotation angle of the torsion bar 40a on the pinion side (pinion shaft 12b side) based on the signal from the motor rotation angle sensor 49 and a reduction ratio of the speed reduction device 17 (step S7). The base positions described above may be calculated by averaging the base positions in the past calculations. An initial base position just after system start-up may be retrieved from a memory medium such as an EEPROM or the like (not shown in figures) in the steering controller 30.

The base assist control amount is calculated based on the steering torque calculated in step S4 described above.

When the torque sensor operation is determined as abnormal based on an output from the torque sensor 40 (step S3: YES), calculation for the base assist control mount based on the steering torque derived from the torque sensor output signal is stopped. Then, difference between the rotation angle of the torsion bar 40a on the steering wheel 10 side (steering shaft 12a side) and the base position calculated in step S6 is calculated (step S9). A difference between the rotation angle of the torsion bar 40a on the pinion side (pinion shaft 12b side) and the base position calculated in step S7 is also calculated accordingly (step S10).

An estimated twist angle of the torsion bar 40a is calculated as a difference between the rotation angle of the torsion bar 40a on the steering wheel 10 side (steering shaft 12a side) with a deviation from the base position and the rotation angle of the torsion bar 40a on the pinion side (pinion shaft 12b side) with a deviation from the base position (step S11).

An alternative steering torque is calculated by multiplying the estimated twist angle of the torsion bar 40a with the spring constant of the torsion bar 40a (step S12). This alternative steering torque is used for calculation of the base assist control amount (step S13).

While the invention has been particularly shown and described with reference to the preferred embodiment thereof, it will be understood by those skilled in the art that various changes in form and details may be made without departing from the spirit and scope of the invention.

1. A vehicle electric power steering system having an electric motor that gives torque to a steering mechanism including a steering shaft and a pinion shaft based on an operation of a steering wheel, the system comprising:
a torque sensor including a torsion bar that detects a steering force of the steering wheel for controlling the electric motor;
an abnormality detection means that detects an abnormality of the torque sensor;
a first rotation angle detection means that detects a rotation angle of the steering shaft connecting the steering wheel and one end of the torsion bar;
a second rotation angle detection means that detects a rotation angle of the pinion shaft connecting a pinion and the other end of the torsion bar; and
an alternative torque calculation means that calculates an alternative steering force for controlling the electric motor based on the steering shaft rotation angle and the pinion shaft rotation angle when the abnormality of the torque sensor is detected by the abnormality detection means.

2. The vehicle electric power steering system according to claim 1,
wherein the alternative torque calculation means determines a base position of the steering shaft and a base position of the pinion shaft while the torque sensor is working correctly.

3. The vehicle electric power steering system according to claim 2,
wherein the alternative torque calculation means calculates an alternative steering torque from an estimated twist angle of the torsion bar based on the comparison between the rotation angle of the one end of the torsion bar with a deviation from the base position and the rotation angle of the other end of the torsion bar with a deviation from the base position when an abnormality of the torque sensor is detected by the abnormality detection means.

4. A method of compensating abnormality of the torque sensor by calculating an alternative steering torque in a vehicle electric power steering system, the method comprises steps of:
detecting a steering shaft rotation angle;
detecting a pinion shaft rotation angle;
detecting an abnormality of the torque sensor;
calculating a steering torque based on the output of the torque sensor while the torque sensor is working normally; and
calculating an alternative steering torque from an estimated steering angle based on the difference between the rotation angle of the steering shaft and the rotation angle of the pinion shaft when the abnormality is detected by the abnormality detection means.
